(19) United States
(12) Patent Application Publication
(10) Pub. No.: US 2026/0120038 A1
(43) Pub. Date: Apr. 30, 2026

(54) AUTOMATED TRAINING SYSTEMS FOR EMERGENCY COMMUNICATION CENTERS

(71) Applicants: Scott MacDonald, Seward, NE (US); Alex Montgomery, San Diego, CA (US); Robert Legaye, Portland, OR (US)

(72) Inventors: Scott MacDonald, Seward, NE (US); Alex Montgomery, San Diego, CA (US); Robert Legaye, Portland, OR (US)

(21) Appl. No.: 19/324,673

(22) Filed: Sep. 10, 2025

Related U.S. Application Data
(60) Provisional application No. 63/713,972, filed on Oct. 30, 2024.

(51) Int. Cl. G06Q 10/0639; G06F 40/35; G09B 5/02; G09B 7/02; H04M 3/51

(52) U.S. Cl. CPC G06Q 10/06395; G06F 40/35; G09B 5/02; G09B 7/02; H04M 3/5116; H04M 2242/04

(57) ABSTRACT

Automated training systems including an integrator module, a content merit module, and a simulation module. The integrator module is configured to access event component data from different data sources and to generate a composite event data file for a given event. The content merit module is in data communication with the integrator module and configured to access the composite event data file, to compare the composite event data file to predetermined criteria, and to generate a content merit score based on the comparison of the composite event data file to the predetermined criteria. The simulation module is in data communication with the integrator module and the content merit module and configured to access a selected composite event data file and to generate a simulated event data file. The selected composite event data file has a content merit score that exceeds a predetermined content merit threshold.

### CROSS REFERENCE TO RELATED APPLICATIONS

This application claims priority to copending U.S. Application, Ser. No. 63/713,972, filed on Oct. 30, 2024, which is hereby incorporated by reference for all purposes.

### BACKGROUND

The present disclosure relates generally to training systems. In particular, automated training systems for emergency communication centers are described.

Emergency communication centers are vital for public safety by serving as a link between the public and emergency response services. Examples of emergency communication centers include public safety answering points (PSAPs), emergency service dispatch centers, and 911 call centers. Emergency communication centers answer, triage, and manage emergency and non-emergency calls and dispatch appropriate responses. Dispatching appropriate responses often includes dispatching first responders from the police, the fire department, or emergency medical services.

Training is essential for individuals working in emergency communication centers because delays or mistakes can be the difference between life and death for those experiencing an emergency. Conventional methods of training emergency communication center personnel are not as effective or efficient as would be ideal.

For example, conventional training methods require human facilitators and evaluators. Using people to facilitate emergency communication center training and to evaluate a trainee's proficiency with the training subject matter is tedious, time consuming, expensive, and subjective. It would be desirable to have less labor intensive means to train and evaluate emergency communication center personnel. Automated systems to train and evaluate emergency communication center individuals would be ideal.

Another drawback of conventional training systems is that they rely on scripted scenarios, which lack realism. Scripted scenarios are prone to not accurately reflect real-world complexities and are often dated. Presenting scripted scenarios requires human actors, which adds hassle, cost, and variability to the training process. It would be beneficial if real-world examples could be presented to trainees to dispense with the need for human actors to present scripted scenarios.

Thus, there exists a need for training systems for emergency communication centers that improve upon conventional training systems. Examples of new and useful automated training systems for emergency communication centers addressing the needs existing in the field are discussed below.

### SUMMARY

The present disclosure is directed to automated training systems for emergency communication centers. The automated training systems include an integrator module, a content merit module, and a simulation module.

The integrator module is configured to execute programmed instructions to access event component data corresponding to real-world emergency events from different data sources, and generate a composite event data file for a given event by integrating the event component data corresponding to the given event into a single data file.

The content merit module is in data communication with the integrator module. The content merit module is configured to execute programmed instructions to access the composite event data file, compare the composite event data file to predetermined criteria for evaluating the training merit of content for emergency communication centers, and generate a content merit score based on the comparison of the composite event data file to the predetermined criteria for training merit.

The simulation module is in data communication with the integrator module and the content merit module. The simulation module is configured to execute programmed instructions to access a selected composite event data file and generate a simulated event data file based on the selected composite event data file. The selected composite event data file has a content merit score that exceeds a predetermined content merit threshold. The simulated event data file is configured for training or testing at emergency communication centers.

### BRIEF DESCRIPTION OF THE DRAWINGS

FIG. 1 is a schematic view of a first example of an automated training system for emergency communication centers.

FIG. 2 is a schematic view of a simulation module of the automated training system shown in FIG. 1 generating a simulated event data file with selected actual dialogue from a composite event data file excluded and with a prompt for a trainee or candidate to provide a response appropriate for the selected actual dialogue excluded.

FIG. 3 is a schematic view of a simulation module of the automated training system shown in FIG. 1 generating a simulated event data file with selected actual dialogue from a composite event data file excluded, simulated dialogue added, and with a prompt for a trainee or candidate to provide a response appropriate for the selected actual dialogue excluded.

FIG. 4 is a flow diagram of program instructions executed by an integrator module of the automated training system shown in FIG. 1.

FIG. 5 is a flow diagram of program instructions executed by a content merit module of the automated training system shown in FIG. 1.

FIG. 6 is a flow diagram of program instructions executed by a simulation module of the automated training system shown in FIG. 1.

FIG. 7 is a flow diagram of program instructions executed by a training module of the automated training system shown in FIG. 1.

FIG. 8 is a flow diagram of program instructions executed by an examination module of the automated training system shown in FIG. 1.

FIG. 9 is a flow diagram of program instructions executed by a reporter module of the automated training system shown in FIG. 1.

### DETAILED DESCRIPTION

The disclosed automated training systems will become better understood through review of the following detailed description in conjunction with the figures. The detailed description and figures provide merely examples of the various inventions described herein. Those skilled in the art will understand that the disclosed examples may be varied, modified, and altered without departing from the scope of the inventions described herein. Many variations are contemplated for different applications and design considerations; however, for the sake of brevity, each and every contemplated variation is not individually described in the following detailed description.

Throughout the following detailed description, examples of various automated training systems are provided. Related features in the examples may be identical, similar, or dissimilar in different examples. For the sake of brevity, related features will not be redundantly explained in each example. Instead, the use of related feature names will cue the reader that the feature with a related feature name may be similar to the related feature in an example explained previously. Features specific to a given example will be described in that particular example. The reader should understand that a given feature need not be the same or similar to the specific portrayal of a related feature in any given figure or example.

### Definitions

The following definitions apply herein, unless otherwise indicated.

“Substantially” means to be more-or-less conforming to the particular dimension, range, shape, concept, or other aspect modified by the term, such that a feature or component need not conform exactly. For example, a “substantially cylindrical” object means that the object resembles a cylinder, but may have one or more deviations from a true cylinder.

“Comprising,” “including,” and “having” (and conjugations thereof) are used interchangeably to mean including but not necessarily limited to, and are open-ended terms not intended to exclude additional elements or method steps not expressly recited.

Terms such as “first”, “second”, and “third” are used to distinguish or identify various members of a group, or the like, and are not intended to denote a serial, chronological, or numerical limitation.

“Coupled” means connected, either permanently or releasably, whether directly or indirectly through intervening components.

“Communicatively coupled” means that an electronic device exchanges information with another electronic device, either wirelessly or with a wire-based connector, whether directly or indirectly through a communication network.

“Controllably coupled” means that an electronic device controls operation of another electronic device.

### Automated Training Systems for Emergency Communication Centers

With reference to the figures, novel automated training systems for emergency communication centers will now be described. The novel training systems discussed herein function to train emergency communication center personnel on policies and procedures for handling emergency and non-emergency communications and for dispatching emergency services.

In more detail, the training systems collect real-world data, including Computer-Aided Dispatch (CAD) details, audio files of emergency and non-emergency calls, and radio transmissions from agency voice logging recorders. The training systems assemble these elements into real-world events.

The training systems automatically evaluate the performance of call takers and dispatchers involved with the assembled real-world events. Performance is evaluated against national standards or agency-specific requirements. In some cases, artificial intelligence processing is utilized for performance evaluations of the events.

The training systems then leverage the performance evaluations to generate training simulations derived from actual events. In some examples, the simulations are generated via artificial intelligence processes. The simulations are tailored to improve specific skills and can be used by new hires, trainees, and veteran personnel to practice routine and rare emergency scenarios.

Upon completion of the simulations, the training systems process the trainee's performance in the simulation. Processing the trainee's performance may include transcribing the audio that occurred during the simulation, including what the trainee communicated during the simulation. Processing the trainee's performance may also include evaluating the trainee's compliance with policies, standards, and requirements.

The training systems are configured to present data corresponding to the trainee's performance. The data may be presented through dashboards and reports. The performance data may be accessible to trainees, instructors, and leadership.

The reader will appreciate from the figures and description below that the presently disclosed training systems address many of the shortcomings of conventional training systems for emergency communication centers. For example, the novel training systems do not require human facilitators and evaluators like conventional training methods. Accordingly, the novel training systems reduce tedium, time consumption, expense, and subjectivity compared to conventional approaches that rely on people to facilitate emergency communication center training and to evaluate a trainee's proficiency with the training subject matter. Desirably, the novel training systems provide less labor intensive, automated means to train and evaluate emergency communication center personnel.

Realistic training material is another advance of the novel training systems. Rather than relying on unrealistic, dated, and scripted scenarios, the novel training systems utilize real-world audio of emergency communications as training material. Moving beyond scripted scenarios reduces or eliminates the need for human actors, which reduces hassle, cost, and variability in the training process.

### Automated Training System Embodiment One

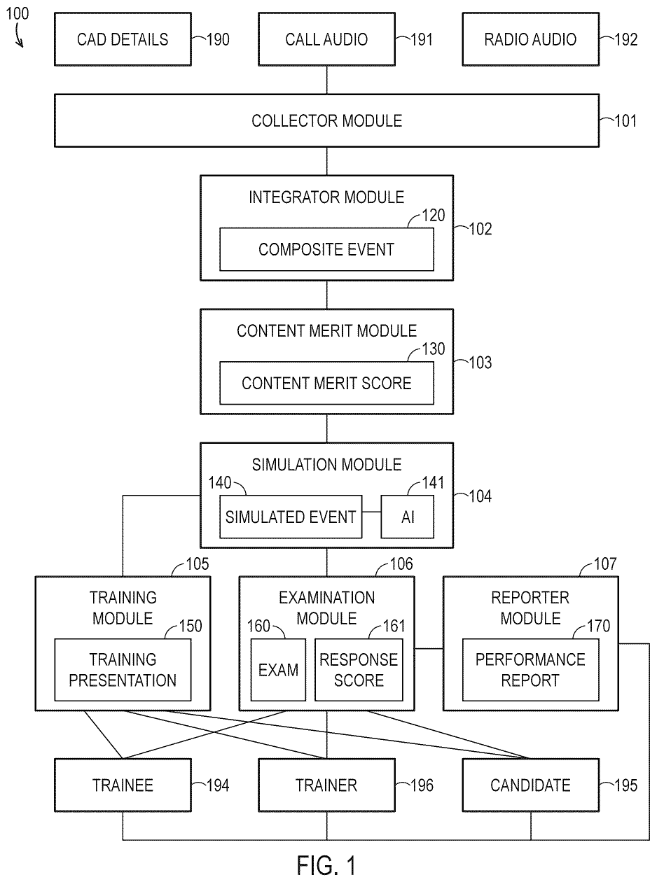

With reference to FIGS. 1-9, a first example of an automated training system, automated training system 100, will now be described. As shown in FIG. 1, automated training system 100 includes a multiple computing modules. The computing modules include a collector module 101, an integrator module 102, a content merit module 103, a simulation module 104, a training module 105, an examination module 106, and a reporter module 107. The computing modules of training system 100 are described in the sections below.

In some examples, the training system does not include one or more modules included in training system 100. In other examples, the training system includes additional or alternative modules or features.

With continued reference to FIG. 1, the reader can see that training system 100 interacts with different sources of data. For example, training system 100 is in data communication with one or more data stores providing CAD detail files 190, call audio files 191, and radio audio files 192. Additionally or alternatively, the training system may be in data communication with a data store with image and/or video files.

FIG. 1 demonstrates that different users interact with training system 100. For example, as depicted in FIG. 1, a trainee 194, a candidate 195, and a trainer 196 interact with training system 100.

In particular, trainee 194 and candidate 195 interact with training module 105, examination module 106, and reporter module 107 for training exercises and proficiency testing. Trainer 196 utilizes training module 105 and examination module 106 to select training routines and examinations for trainees and candidates. The users may interact with reporter module 107 to review trainee and candidate performance with training routines and examinations.

Trainee 194 may be a new hire or an experienced staff member. Experienced staff members include individuals who have at least a basic knowledge of emergency communication center policies and procedures, including veteran members with extensive experience. New hires include individuals who have not yet demonstrated basic proficiency with required policies and procedures.

Candidate 195 is an individual taking an examination to demonstrate proficiency with emergency communication center policies and procedures and/or to demonstrate suitability for a position in a hiring context. Candidate 195 may be a new hire, and experienced staff member, or an individual seeking a position with an emergency call center.

Trainer 196 is meant to be broadly construed and includes supervisors, managers, instructors, mentors, or any other personnel associated with facilitating training and testing in emergency communication centers. Trainer 196 interacts with integrator module 102, content merit module 103, simulator module 104, training module 105, examination module 106, and reporter module 107 to assist or oversee multiple aspects of training system 100. For example, with reference to FIG. 1, trainer 196 may assist with or oversee generating composite events 120; assessing composite events based on content merit scores 130; generating simulated events 140; generating and/or distributing training presentations 150; generating and/or distributing exams 160; and/or generating or reviewing performance reports 170.

### Collector Module

Collector module 101 functions to receive real-world event data to be considered and used for training and examination purposes. The real-world event data received by collector module 101 includes CAD detail files 190, call audio files 191, and radio audio files 192. In some examples, the collector module additionally or alternatively receives image and video files.

CAD details 190 include time, date, location, and other contextual details related to communications with emergency communication centers. For example, the CAD details may specify that a house fire call was received by an emergency communication center on Oct. 2, 2024, in Sacramento, California, by an elderly female at 7:04 PM when local firefighter resources were already involved with other fire events.

Call audio files 191 represent recordings of dialogue between someone calling an emergency communication center and a representative at the emergency communication center. The call may involve an emergency or a non-emergency. The call audio file may be in any currently known or later developed data file format, such as .wav, .mp3, or .flac. In some instances, the call audio file is included in the CAD details.

Radio audio files 192 represent recordings of dialogue between a representative of an emergency communication center and first responders via radio transmissions. While most communications with first responders occurs via radio transmissions, the collector module may receive audio data between an emergency communication center and first responders that occur via telephone as well. The radio audio file may be in any currently known or later developed data file format, such as .wav, .mp3, or .flac. In some instances, the radio audio file is included in the CAD details.

Collector module 101 includes computer networking hardware and programming to facilitate receiving the real-world event data. Collector module 101 also includes a processor configured to process the real-world event data into desired file formats. For example, the processor may convert an audio file in an .mp3 format to a .wav format. Further, collector module 101 includes computer memory to store the real-world event data received.

Collector module 101 is in data communication with integrator module 102. Collector module 101 being in data communication with integrator module 102 enables integrator module 102 to access the real-world data event stored in the computer memory of collector module 101 when generating composite events 120.

### Integrator Module

Integrator module 102 is configured to compile the real-world event data collected by collector module 101 into composite events 120. For example, a particular CAD detail file 190, call audio file 191, and radio audio file 192 may all correspond to the same event. Integrator module 102 functions to combine the three independent sources of data into a single data file defining a composite event 120.

As shown in FIG. 1, integrator module 102 is in data communication with collector module 101, content merit module 103, and simulation module 104. Content merit module 103 evaluates composite events 120 for suitability in training presentations 150 or exams 160 managed by training module 105 and examination module 106, respectively. Simulation module 104 may use composite events 120 to generate a simulated event 140 when content merit module 103 establishes that composite events 120 are good candidates for training or examination simulations. Whether system 100 uses simulation module 104 to generate a simulation based on a given real-world event depends on the training merit of the real-world event, reflected in a merit score 130, as determined by content merit module 103 and explained further in the content merit module section.

Integrator module 102 may combine the real-world event data into a composite event 120 in any currently known or later developed file type or form. For example, the integrator module may combine the files into a PowerPoint® presentation file with a .ppt file type or may combine the files into an Adobe® Acrobat® document with a .pdf file type. In some examples, the real-world event data is combined via related records in data tables of a relational database.

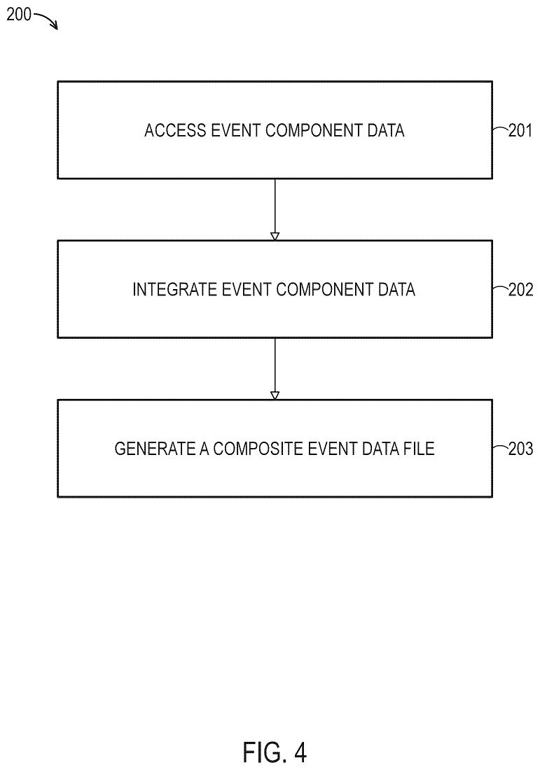

With reference to FIG. 4, the reader can see programmed instructions 200 that integrator module 102 is configured to execute. The integrator module may execute additional, fewer, or alternative programmed instructions in other examples.

In a first step 201 of programmed instructions 200, integrator module 102 accesses different components of real-world event data collected by collector module 101, such as CAD detail files 190, call audio files 191, and radio audio files 192. Integrator module 102 integrates the different components of real-world event data related to a common event at step 202. With continued reference to FIG. 4, at step 203, integrator module 102 generates a single data file defining a composite event 120 from the different components of real-world event data integrated at step 202.

### Content Merit Module

Content merit module 103 is configured to evaluate composite events 120 generated by integrator module 102 to determine how well composite events 120 serve as training presentations 150 or exams 160.

Beneficially, content merit module 103 is configured to automate evaluation of composite events 120 generated by integrator module 102 and deriving from real-world events collected by collector module 101, such as CAD detail files 190, call audio files 191, and/or radio audio files 192. Content merit module 103 assesses composite events 120 for suitability as training presentations 150 or examinations 160 in system 100. As shown in FIG. 1, content merit module 103 generates a content merit score 130 reflecting the suitability of a given composite event 120 for training presentations 150 and/or examinations 160.

In some examples, the evaluation module is configured to partially automate assessments of real-world content and to incorporate manual human assessment contributions as well. In the present example, content merit module 103 utilizes artificial intelligence processing and machine learning to evaluate composite events 120. The content merit module may use any currently known or later developed technology and methodology for automating content suitability assessments.

A simulated event 140 may be generated by simulation module 104 when a composite event 120 generated by integrator module 102 is evaluated favorably by content merit module 103. For example, system 100 may use simulation module 104 to generate a simulated event 140 to be incorporated into a training presentation 150 or an exam 160 when content merit module 103 determines that composite event 120 closely correlates with national standards and other predefined criteria for handing emergency communication center communications. Composite events that are evaluated poorly by content merit module 103 may be selected for simulated events demonstrating what trainees should avoid doing.

Favorable assessments may be reflected quantitatively with a numerical content merit score 130 generated by content merit module 103. For example, a predefined numerical threshold for suitability as training or examination content may be established, such as 80 out of 100, and content merit module 103 may deem composite events 120 with content merit scores 130 greater or equal to 80 to be suitable for training or examination content. Conversely, content merit module 103 may deem composite events 120 with content merit scores of 79 and below to be unsuitable.

Predefined criteria used by content merit module 103 may include a wide range of user-defined parameters. For example, the predefined criteria may include parameters based on a given emergency communication center's policies, local rules and customs, or preferences of a given supervisor.

When evaluating composite events 120 for suitability in training presentations 150 and/or exams 160, the artificial intelligence processing utilizes data sets of national, state, and local standards for emergency communication center call handling and first responder dispatching and other predefined criteria. Content merit module 103 also utilizes voice detection and dialogue comprehension modules. The dialogue interpreted by the artificial intelligence system for each person speaking in a composite event is compared against specified standards and other predefined criteria to assess how well the dialogue comports with the standards and criteria.

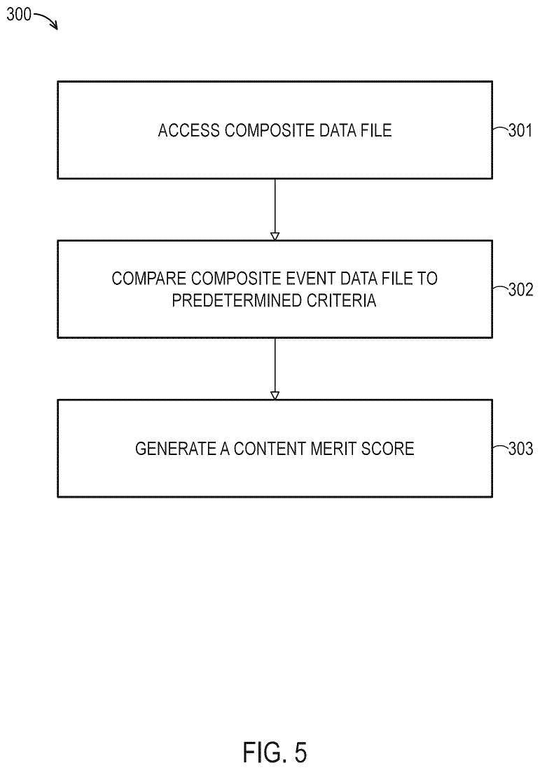

FIG. 5 depicts programmed instructions 300 that content merit module 103 is configured to execute. The content merit module may execute additional, fewer, or alternative programmed instructions in other examples.

In a first step 301 of programmed instructions 300, content merit module 103 accesses data files of composite events 120 generated by integrator module 102. Content merit module 103 compares a composite event 120 to predetermined criteria at step 302. The predetermined criteria may be a collection of specified standards for emergency call center procedure training and/or examination.

With continued reference to FIG. 5, at step 303, content merit module 103 generates a content merit score 130. Content merit score 130 represents how well a composite event 120 comports with the standards and criteria used for comparison in step 302.

### Simulation Module

Simulation module 104 generates simulations from selected composite events 120. The selected real-world events used by simulation module 104 to generate simulations are those deemed good candidates for simulations by content merit module 103. The simulations generated by simulation module are shown in FIG. 1 as simulated events 140.

Simulated events 140 generated by simulation module 104 supplement and enhance composite events 120 comprised of real-world data. Simulated events 140 are used by training module 105 to generate training presentations 150 for trainees 194. Moreover, simulated events 140 are used by examination module 106 to generate proficiency exams 160 for candidates 194.

The reader can see in FIG. 1 that simulation module 104 is in data communication with integrator module 102, content merit module 103, training module 105, and examination module 106. Simulation module 104 receives selected composite events 120 from integrator module 102 and generates simulated events 140 from the selected composite event 120 data. Simulation module 104 delivers simulated events 140 it generates to training module 105 to use in training presentations 150 for trainees 194 and to examination module 106 to use in exams 160 taken by candidates 195.

The simulation module may generate simulations by any currently known or later developed means, including artificial intelligence processing with artificial intelligence module 141 included in simulation module 104. In the present example, as shown in FIG. 1, simulation module 104 includes an artificial intelligence module 141 configured to generate simulated events using artificial intelligence processing.

The simulations in the simulated events may be scripted, unscripted, or a combination of scripted and unscripted content. The simulations may be customized or edited to focus on desired aspects of a given real-world event, such as a more common aspect of a given event or a rare aspect of a given event.

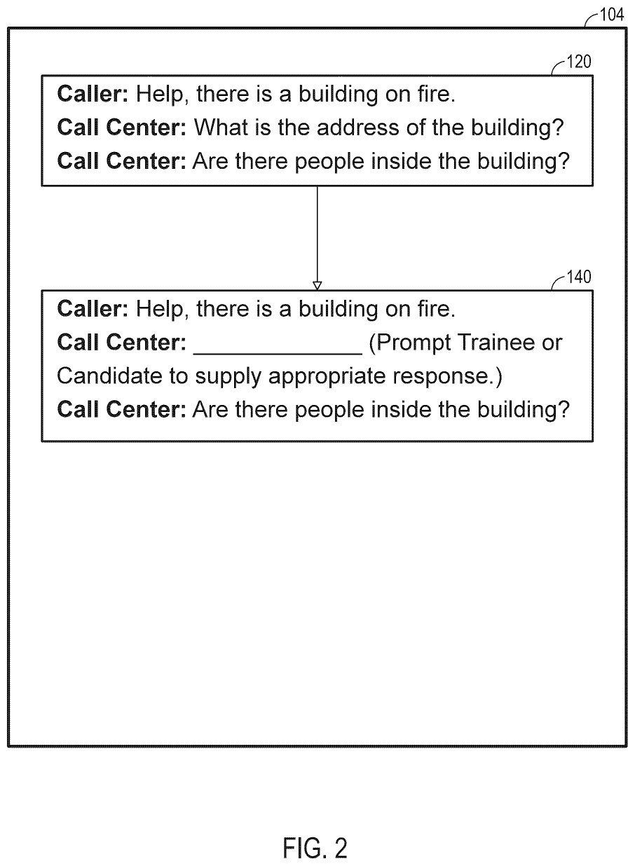

As shown with a blank line in FIG. 2, simulation module 104 is configured to selectively remove selected dialogue from composite event 120 while keeping other dialogue when generating simulated event 140. As demonstrated in FIG. 2, the dialogue selectively removed from composite event 120 in simulated event 140 is that of emergency communication personnel, “What is the address of the building?” The dialogue of composite event 120 selectively retained in simulated event 140 includes dialogue of the person calling the emergency communication center and selected dialogue of first responders in the real-world event.

As demonstrated in FIG. 2, removing the actual dialogue of emergency communication personnel from simulated event 140 enables trainee 194 or candidate 195 to step into that person's shoes for training or testing purposes. When simulated event 140 is incorporated into a training presentation 150, the omitted dialogue may prompt trainee 194 to critically consider what he or she would communicate in the real-world scenario. When simulated event 140 is incorporated into an exam 160, the omitted dialogue provides an opportunity for candidate 195 to demonstrate that he or she would handle the real-world scenario effectively and consistent with predefined criteria.

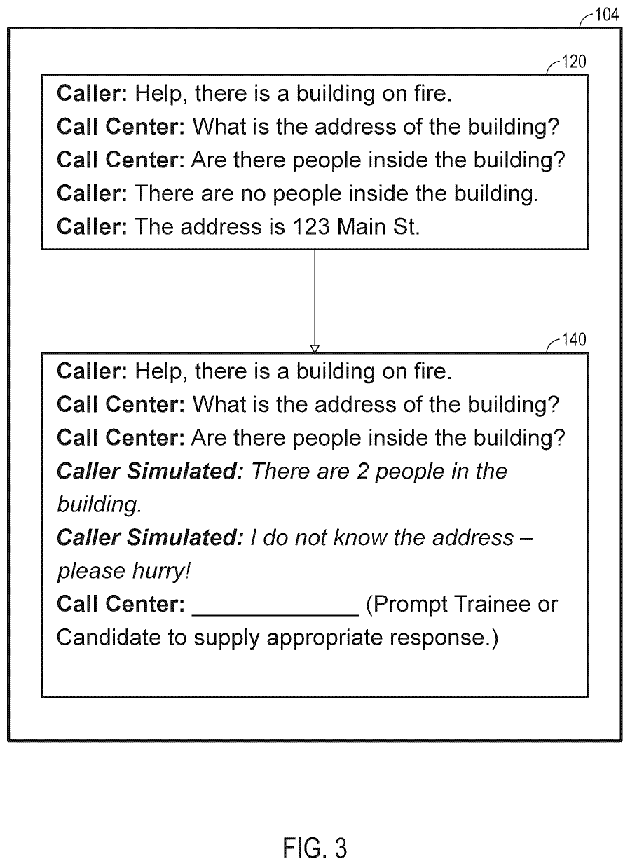

As shown in italic text in FIG. 3, simulation module 104 is also configured to generate dialogue to selectively add to existing dialogue from composite event 120 when generating simulated event 140. The dialogue added in FIG. 3 was generated by artificial intelligence processing with artificial intelligence module 141. Dialogue may be added to or modified in simulated event 140 by simulation module 104 to selectively modify the circumstances of the real-world event and/or to provide instructive context to the real-world event.

For example, in FIG. 3, simulation module 104 generates simulated text, “There are 2 people in the building. I do not know the address-please hurry!” in simulated event 140. The simulated text in simulated event 140 replaces the actual dialogue, “There are no people inside the building. The address is 123 Main St.” in composite event 120.

Replacing the actual dialogue with simulated dialogue in the FIG. 3 example is useful for training purposed because it depicts a different scenario than the actual event; namely, that people are in danger and the caller does not know the address. The caller not knowing the address provides opportunities to train trainees 192 on procedures for obtaining an address when needed.

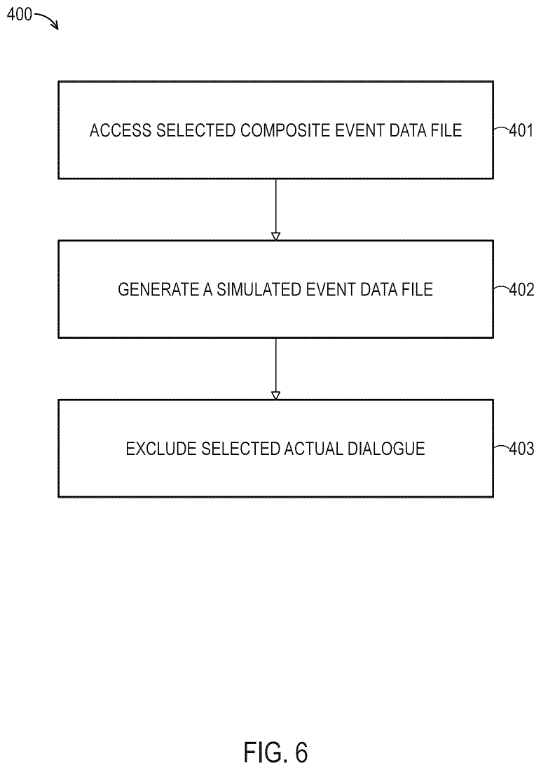

FIG. 6 depicts programmed instructions 400 that simulation module 104 is configured to execute. The simulation module may execute additional, fewer, or alternative programmed instructions in other examples.

In a first step 401 of programmed instructions 400, simulation module 104 accesses a data file of a composite event 120 generated by integrator module 102. At step 402, simulation module 104 generates a simulated event 140 and saves simulated event 140 in a data file. Simulated event 140 is based on composite event 120 accessed in step 401.

At step 403, simulation module 104 excludes selected actual dialogue that existed in the composite event data file. As shown in FIG. 2, excluding actual dialogue at step 403 may facilitate prompting trainees to supply appropriate dialogue in place of excluded dialogue for training purposes in a training presentation. Additionally or alternatively, excluding actual dialogue at step 403 may facilitate prompting candidates to supply the appropriate dialogue in place of the excluded dialogue for examination purposes.

### Training Module

Training module 105 is configured to generate training presentations 150 based on composite events 120 generated by integrator module 102 and/or based on simulated events 140 generated by simulator 104. Training module 105 makes training presentations 150 available to trainees 194 for training purposes. Training presentations 150 generated by training module 105 may demonstrate proper and improper examples of fielding emergency communication center calls and of dispatching first responders.

As shown in FIG. 1, training module 105 is in data communication with content merit module 103, simulation module 104, and computing terminals used by trainee 194 and supervisors 196. Training module 105 receives composite events 120 and simulated events 140 to generate training presentations 150 from integrator module 102 and simulation module 104, respectively. Pursuant to requests from trainees 194 and/or trainers 196, training module 105 delivers training presentations 150 to trainees 194.

Training presentations 150 may include a wide variety of content and may be generated or distributed in a wide variety of formats. For example, the training presentations may be presented as recorded, fixed presentations led by an instructor; live, interactive presentations or workshops led by an instructor; text and image presentations; and audiovisual presentations. Training module 105 is configured to facilitate real-time interactions between trainers 196 and trainees 194 and/or between trainees 194 in some instances.

Training module 105 is further configured to monitor engagement of trainees 194 and their progress over time. Monitoring user engagement may facilitate using machine learning to automatically refine training presentations and/or simulated events. Additionally or alternatively, monitoring user engagement may facilitate manually assessing and refining training presentations and/or simulated events.

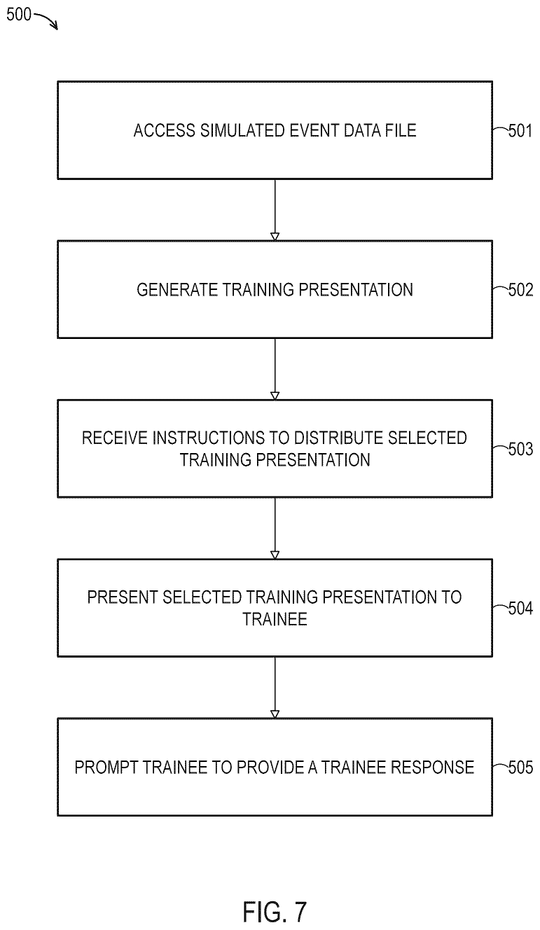

FIG. 7 depicts programmed instructions 500 that training module 105 is configured to execute. The training module may execute additional, fewer, or alternative programmed instructions in other examples.

In a first step 501 of programmed instructions 500, training module 105 accesses a data file of a simulated event 140 generated by simulation module 104. At step 502, training module 105 generates a training presentation 150 based on simulated event 140 accessed in step 501. Additionally or alternatively to simulated events, the training presentation generated by the training module may be based on a composite event.

At step 503, training module 105 receives instructions to distribute a selected training presentation. The instructions received at step 503 may come from a trainer or a trainee. In some examples, candidates are authorized to request training presentations from the training module as well.

With continued reference to FIG. 7, training module 105 presents a selected training presentation 150 to a trainee 194 at step 504. Presenting a training presentation 150 at step 504 may include sending a complete data file to a trainee's computing device or streaming content to a trainee's computing device. Of course, the training module may present a training presentation on a local computer operated by a trainer or other emergency call center member.

At step 505, training module 105 prompts trainee 194 to provide a trainee response. Examples of prompts for a trainee response are depicted in FIGS. 2 and 3 with blank lines indicating dialogue portions a trainee is prompted to supply. The trainee response prompted at step 505 enables the trainee to participate more actively in the training and to demonstrate proficiency or lack thereof of emergency call center policies and procedures.

### Examination Module

Examination module 106 generates exams 160 based on composite events 120 and simulated events 140 to test proficiency of candidates 195 with emergency call center policies and procedures. Examination module 106 is configured to automatically evaluate the performance of candidates 195 on questions in an examination 160.

Referencing FIGS. 1-3 and 8, examination module 106 is in data communication with integrator module 102 and simulation module 104 to receive composite events 120 and simulated events 160 to generate exams 160. Blank lines and prompts for responses in FIGS. 2 and 3 represent questions suitable for exams 160. The reader can see in FIGS. 2 and 3 that the questions correspond to omitted dialogue from composite events 120 incorporated into simulated events 140. Omitting the dialogue provides a candidate with an opportunity to demonstrate competency with emergency call center procedures and policies by supplying an appropriate response in place of the omitted dialogue given the context and circumstances of simulated event 140.

Further, examination module 106 is configured to generate a response score 161 based on the suitability of an answer that candidate 195 provides for a question in examination 160. In the present example, examination module 106 utilizes artificial intelligence processing and machine learning to evaluate response score 161. The suitability of an answer to a question may be based on how close it corresponds to the actual dialogue, collected answers from experienced call center personnel, or other predetermined criteria.

FIG. 1 demonstrates that candidates 195 and trainers 196 are in data communication with examination module 106. Examination module 106 is also in data communication with reporter module 107. Candidates 106 interact with examination module 106 to take examinations 160. Trainers 196 interact with examination module 106 to assist with generating exams 160, to distribute exams 160 to selected candidates 195, and to review and/or revise response scores 161. Examination module 106 sends response scores 161 to reporter module 107 to use when generating a performance report 170 for a candidate 195.

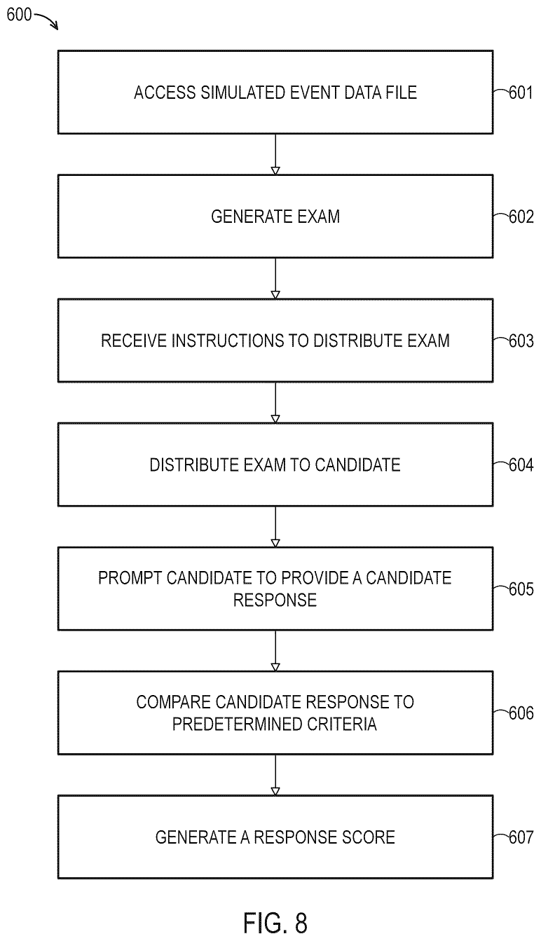

FIG. 8 depicts programmed instructions 600 that examination module 106 is configured to execute. The examination module may execute additional, fewer, or alternative programmed instructions in other examples.

In a first step 601 of programmed instructions 600, examination module 106 accesses a data file of a simulated event 140 generated by simulation module 104. At step 602, examination module 106 generates an exam 160 based on simulated event 140 accessed in step 601. Additionally or alternatively to simulated events, the exam generated by the examination module may be based on a composite event.

At step 603, examination module 106 receives instructions to distribute a selected exam. The instructions received at step 603 may come from a trainer or a candidate.

With continued reference to FIG. 8, examination module 106 distributes a selected exam 160 to a candidate 195 at step 604. Distributing an exam at step 604 may include sending a complete data file to a candidates' computing device or streaming content to a candidates' computing device. In some examples, the examination module may present an exam on a local computer operated by a trainer, other emergency call center member, or third-party testing center.

At step 605 as part of an exam 160, examination module 106 prompts candidate 195 to provide a candidate response to an exam question. Examples of prompts for a candidate response are depicted in FIGS. 2 and 3 with blank lines indicating dialogue portions a candidate is prompted to supply. The candidate response prompted at step 605 enables candidate 195 to demonstrate proficiency or lack thereof of emergency call center policies and procedures.

At step 606, examination module 106 compares the candidate response received at step 605 to predetermined criteria for candidate responses to a given question. The predetermined criteria is selected to establish when a candidate response comports with accepted and/or best practices of emergency call center personnel for given scenarios. At step 607, examination module 106 generates a response score 161 based on the comparison undertaken at step 606. Examination module 106 sends response scores 161 to reporter module 107.

### Reporter Module

Reporter module 107 provides information via performance reports 170 to trainees 194 and trainers 196 pertaining to progress by trainees 194 with training presentations 150. Reporter module 107 also provides information via performance reports to candidates 195 and trainers 196 pertaining to proficiency of candidates 195 on examinations 160.

As shown in FIG. 1, reporter module 107 is in data communication with training module 105 and examination module 106. Reporter module 107 is further in data communication with computing devices of system users, including trainees 194, candidates 195, and trainers 196. Training module 105 shares data with reporter module 107 related to training presentations 150 completed or partially completed by trainees and any performance results of quizzes, tests, or participation prompts in training presentations 150. Examination module 106 shares response scores 161 with reporter module 107 to be incorporated into performance reports 170.

Reporter module 107 is configured to compile the trainee and candidate proficiency data into performance reports 170 highlighting proficiency data. The reporter module may utilize any currently known or later developed software or algorithms to generate the performance reports. In some examples, artificial intelligence processing and machine learning is used to generate reports.

The proficiency data may include overall test scores, statistical analysis related to proficiencies of other trainees and candidates, strengths, weaknesses, and recommended additional training materials. The information in the performance reports may include text and numerical summaries, visualizations, audio and video recordings, and audio transcripts. Reporter module 107 is configured to provide detailed feedback to trainees 194, candidates 195, and trainers 196 based on performance evaluations, including descriptions of performance strengths and weaknesses.

Performance reports 170 generated by reporter module 107 may pertain to an individual trainee and/or to a group of trainees. Likewise, performance reports 170 may reflect an individual candidate's performance on exams and/or a group of candidate's performance on exams. Group metrics may be instructive to trainers for a variety of statistical and optimization purposes.

Performance reports 170 generated by reporter module 107 may be available to the trainees and candidates for whom the results pertain and/or to the trainers overseeing the training or examination of trainees and candidates, respectively. In some instances, the performance reports reflect composite proficiency metrics for a group of trainees or candidates and everyone in the group may access the performance reports via reporter module 107.

Reporter module 107 is configured to transcribe audio supplied by trainees 194 and candidates 195 during training presentations 150 and exams 160. The transcribed audio may be more effective or efficient to relay to trainees 194, candidates 195, or trainers 196 than audio recordings.

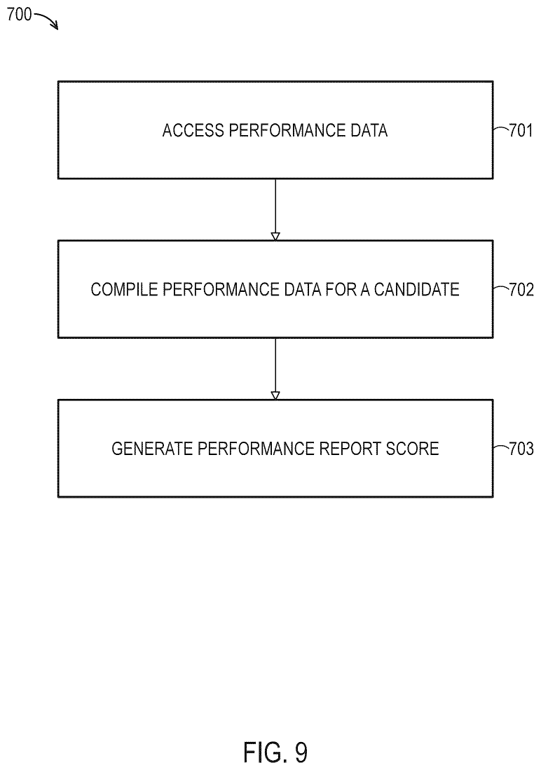

FIG. 9 depicts programmed instructions 700 that reporter module 107 is configured to execute. The reporter module may execute additional, fewer, or alternative programmed instructions in other examples. For example, programmed instructions 700 pertain to generating a performance report 170 for a candidate 195 or trainer 196 detailing how well candidate 195 demonstrated proficiency on an exam 160. In other example, the programmed instructions pertain to generating a performance report for a trainee or trainer detailing the trainee's progress on a training presentation or training curriculum.

In a first step 701 of programmed instructions 700, reporter module 107 accesses performance data for a candidate 195. The performance data is a collection of response scores 161 for questions in exams 160 answered by various candidates 195.

At step 702, reporter module 107 compiles the performance data collected in step 701 for a given candidate. Compiling the performance data at step 702 is specific to a particular exam 160 and specific candidate. However, compiling the performance data may also include compiling performance data for the candidate over multiple exams and/or performance data for a group of candidates for comparison purposes.

At step 703, reporter module 107 generates a performance report 170. Reporter module 107 may present the performance report to the candidate who took the exam and/or to the trainer who selected the exam for the candidate.

The disclosure above encompasses multiple distinct inventions with independent utility. While each of these inventions has been disclosed in a particular form, the specific embodiments disclosed and illustrated above are not to be considered in a limiting sense as numerous variations are possible. The subject matter of the inventions includes all novel and non-obvious combinations and subcombinations of the various elements, features, functions and/or properties disclosed above and inherent to those skilled in the art pertaining to such inventions. Where the disclosure or subsequently filed claims recite “a” element, “a first” element, or any such equivalent term, the disclosure or claims should be understood to incorporate one or more such elements, neither requiring nor excluding two or more such elements.

Applicant(s) reserves the right to submit claims directed to combinations and subcombinations of the disclosed inventions that are believed to be novel and non-obvious. Inventions embodied in other combinations and subcombinations of features, functions, elements and/or properties may be claimed through amendment of those claims or presentation of new claims in the present application or in a related application. Such amended or new claims, whether they are directed to the same invention or a different invention and whether they are different, broader, narrower or equal in scope to the original claims, are to be considered within the subject matter of the inventions described herein.

1. An automated training system for emergency communication centers, comprising:
an integrator module configured to execute programmed instructions to:
access event component data corresponding to real-world emergency events from different data sources; and
generate a composite event data file for a given event by integrating the event component data corresponding to the given event into a single data file;
a content merit module in data communication with the integrator module and configured to execute programmed instructions to:
access the composite event data file;
compare the composite event data file to predetermined criteria for evaluating the training merit of content for emergency communication centers; and
generate a content merit score based on the comparison of the composite event data file to the predetermined criteria for training merit; and
a simulation module in data communication with the integrator module and the content merit module and configured to execute programmed instructions to:
access a selected composite event data file, where the selected composite event data file has a content merit score that exceeds a predetermined content merit threshold; and
generate a simulated event data file based on the selected composite event data file, the simulated event data file being configured for training or testing at emergency communication centers.

2. The automated training system of claim 1, wherein the simulation module is configured to automatically generate simulated dialogue for the simulated event data file.

3. The automated training system of claim 2, wherein the simulation module includes an artificial intelligence module configured to generate simulated dialogue using a large language model.

4. The automated training system of claim 1, wherein:
the composite event data file includes actual dialogue recorded from the given event; and
the simulation module is configured to exclude selected actual dialogue from the simulated event data file.

5. The automated training system of claim 4, wherein the selected actual dialogue excluded from the simulated event data file corresponds to actual dialogue of emergency communication personnel from the given event.

6. The automated training system of claim 5, wherein:
the automated training system further comprises a training module in data communication with the simulation module; and
the training module is configured to execute programmed instructions to generate a training presentation based on the simulated event data file.

7. The automated training system of claim 6, wherein the training module is further configured to execute programmed instructions to present the training presentation to a trainee on a computing device for training purposes.

8. The automated training system of claim 7, wherein the training module is further configured to execute programmed instructions to prompt a trainee to provide a trainee response that is an appropriate replacement for the selected actual dialogue excluded from the simulated event data file on which the training presentation is based.

9. The automated training system of claim 6, wherein the training module is configured to generate the training presentation automatically without human editing.

10. The automated training system of claim 6, wherein the training module is further configured to execute programmed instructions to:
receive instructions from a trainer to distribute a selected training presentation to a selected trainee; and
to distribute the selected training presentation to the selected trainee.

11. The automated training system of claim 5, wherein:
the automated training system further comprises a examination module in data communication with the simulation module; and
the examination module is configured to execute programmed instructions to adapt the simulated event data file into an exam for a candidate to demonstrate proficiency with emergency call center knowledge and skills.

12. The automated training system of claim 11, where the examination module is further configured to execute programmed instructions to distribute the exam to a candidate on a computing device.

13. The automated training system of claim 12, wherein the examination module includes programmed instructions to:
prompt a candidate to attempt to specify a candidate response that is an appropriate replacement for the selected actual dialogue excluded from the simulated event data file;
compare the candidate response to predetermined criteria for response appropriateness; and
generate a response score based on the comparison of the candidate response to the predetermined criteria for response appropriateness.

14. The automated training system of claim 11, further comprising a reporter module in data communication with the examination module and configured to execute programmed instructions to compile performance data for a candidate presented with the exam, the performance data corresponding to how well the candidate demonstrated proficiency with emergency call center knowledge and skills.

15. The automated training system of claim 14, wherein the reporter module is configured to generate a performance report that summarizes the performance data.

16. The automated training system of claim 1, further comprising a collector module in data communication with the integrator module and configured to access and store the event component data from different data sources.

17. The automated training system of claim 1, wherein the event component data includes computer-aided dispatch data.

18. The automated training system of claim 1, wherein the event component data includes call audio data corresponding to recordings of phone calls to emergency call centers.

19. The automated training system of claim 1, wherein the event component data includes radio audio data corresponding to recordings of radio communications of emergency first responders.

20. The automated training system of claim 1, wherein the simulated event data file is generated by the simulation module without scripted content from an actor.
